(19) United States
(12) Patent Application Publication
(10) Pub. No.: US 2011/0236726 A1
(43) Pub. Date: Sep. 29, 2011

(54) BATTERY PACK

(76) Inventors: Jae-Young Ha, Yongin-si (KR); Ike Park, Yongin-si (KR)

(21) Appl. No.: 12/972,171

(22) Filed: Dec. 17, 2010

(30) Foreign Application Priority Data
Mar. 29, 2010 (KR) 10-2010-0027961

(51) Int. Cl. H01M 2/00; H01M 2/02

(52) U.S. Cl. 429/7; 429/163

(57) ABSTRACT

There is provided a battery pack capable of unfolding support members in the use of an external device having the battery pack joined thereto, and inserting the support members respectively into groove portions in the movement of the external device. The battery pack includes at least one battery cell. A case accommodates the battery cells, and is formed as a portion of the external appearance of an external device. The battery pack further includes groove portions formed in a region at which the battery cells are not positioned in the interior of the case and support members respectively inserted into or protruded from the groove portions. Accordingly, the external device can be more conveniently used, and the external appearance of the external device can be formed slimmer in the movement of the external device.

### CROSS-REFERENCE TO RELATED APPLICATION

This application claims the benefit of Korean Patent Application No. 10-2010-0027961, filed Mar. 29, 2010 in the Korean Intellectual Property Office, the disclosure of which is incorporated herein by reference.

### BACKGROUND

1. Field

An aspect of the present invention relates to a battery pack, and more particularly, to a battery pack having a slim external appearance and an improved convenience.

2. Description of the Related Art

As the development and demand of mobile devices have recently been increased, there has been a rapid increase in demand for secondary batteries for use as energy sources. Among these secondary batteries, many studies have been conducted on lithium secondary batteries with high energy density and discharge voltage. Currently, the lithium secondary batteries are commercialized and widely used.

Battery packs are generally classified into a hard pack and an inner pack based on how a secondary battery is mounted to a case. Among these battery packs, the hard pack forms a part of the external appearance of an external device to which it is mounted. Thus, it is easy to mount the hard battery pack to the external device in its use.

Such a hard pack may form a portion of the external appearance of a portable computer such as a notebook computer or tablet computer, which a user can use while carrying it. In portable computers, a great deal of heat is usually generated from a built-in component such as a computer processing unit (CPU). Also, if the portable computer is used in the state that it is put on an object surface such as the upper side of a desk or the floor of a room, heat that is generated from the portable computer is not smoothly radiated. Further, since the portable computer is horizontally put on the object surface, a user's sight is not in correspondence with a display panel, and therefore, it is difficult to operate with the portable computer. Moreover, since a keyboard is positioned parallel with the object surface, it is not easy to perform a keyboard operation. Therefore, a user that uses such a portable computer easily feels tired.

### SUMMARY

In one embodiment, there is provided a battery pack in which groove portions and foldable/unfoldable support members are formed in a region at which battery cells are not positioned in a case of the battery pack, so that the support members can be unfolded while the battery pack is the used with an external device, and the support members can be respectively inserted into the groove portions in the movement of the external device.

According to an aspect of the present invention, there is provided a battery pack including: at least one battery cell; and a case for accommodating the battery cells, the case being formed as a portion of the external appearance of an external device, wherein the battery pack further comprises groove portions formed in a region at which the battery cells are not positioned in the interior of the case and support members respectively inserted into or protruded from the groove portions.

According to an aspect of the invention, the groove portions may be formed at both sides of a rear portion of the external device, respectively.

According to an aspect of the invention, a rotating shaft may be further formed in the groove portion, and the support member may be joined to the rotation shaft.

According to an aspect of the invention, a latching groove may be formed in one region of the groove portion.

According to an aspect of the invention, a projection may be formed in the other region of the support member, corresponding to the region at which the latching groove is positioned.

According to an aspect of the invention, a protection circuit module may be further provided in the interior of the case.

According to an aspect of the invention, a case may be further provided with a connecting portion having one side electrically connected to the protection circuit module and the other side electrically connected to the external device.

According to an aspect of the invention, an external device may be formed using the battery pack.

According to aspects of the present invention, in a battery pack, groove portions and foldable/unfoldable support members are formed in a region at which battery cells are not positioned in a case of the battery pack, so that the support members are unfolded in the use of an external device having the battery pack joined thereto.

According to aspects of the present invention, the external device can be more conveniently used.

According to aspects of the present invention, when the external device is kept or carried, the support members are respectively inserted into the groove portions, so that the external appearance of the external device can be formed slimmer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view showing a notebook computer using a battery pack according to an embodiment of the present invention.

FIG. 2 is a perspective view showing a lower surface of a battery pack according to an embodiment of the present invention.

FIG. 3 is an enlarged perspective view of a supporting member in the battery pack according to the embodiment of the present invention.

FIG. 4A is a front view showing the state that the supporting member is unfolded in the battery pack according to the embodiment of the present invention.

FIG. 4B is a front view showing the state that the supporting member is folded in the battery pack according to the embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

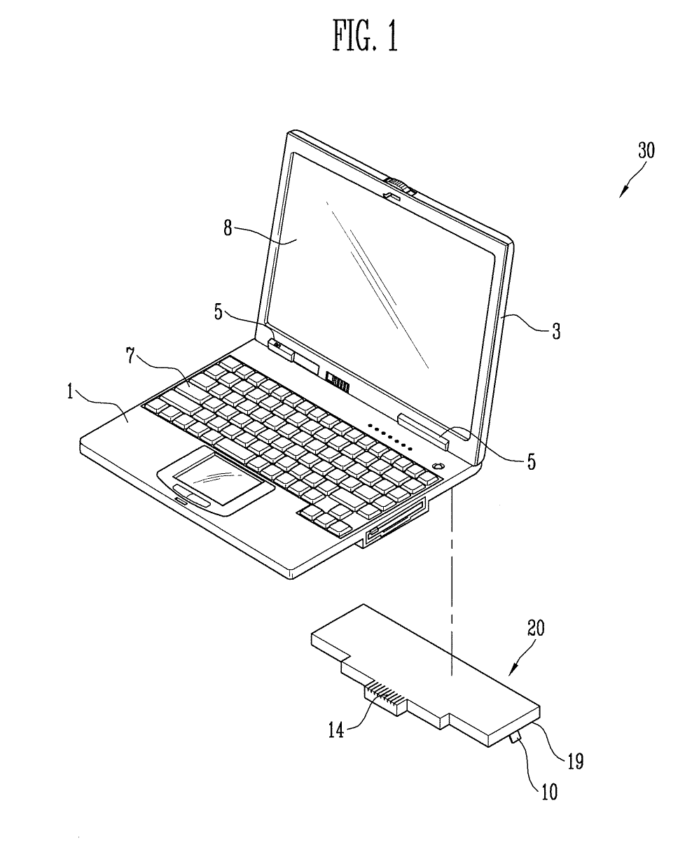

FIG. 1 is a perspective view showing a notebook computer 30 using a battery pack 20 according to an embodiment of the present invention. Referring to FIG. 1, the notebook computer 30 includes a body unit 1 and a display unit 3. The body unit 1 is connected to the display unit 3 through hinge units 5. The notebook computer 30 is kept in the state that the display unit 3 and the body unit 1 are folded to overlap with each other. As illustrated in this figure, the notebook computer 30 is used in the state that the display unit 3 and the body unit 1 are unfolded. While described in terms of the notebook computer 30, it is understood that aspects can be implemented in other devices, such as a tablet computer, a smart phone, a personal media player or netbook.

The body unit 1 has an approximately flat plate shape. A main board and various types of components are installed in the internal space of the body unit 1. A keyboard 7 is an input device and is provided to an upper surface of the body unit 1. Various types of information are displayed on the display unit 3. A display panel 8 is provided to the display unit 3, and a liquid crystal panel is mainly used as the display panel 8. The signal connection of the display unit 3 to the body unit 1 may be made through the hinge units 5. It is understood that aspects of the invention need not include all of the elements shown, such as where a separate keyboard unit 7 is not used as in a touch screen device, and/or a hinge unit 5 Is not used as in certain tablet computers.

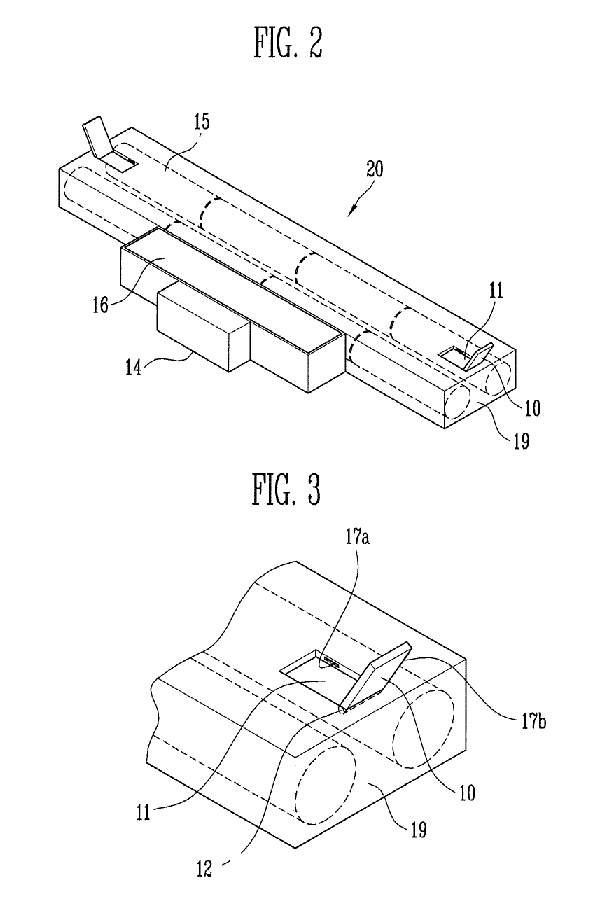

As shown in FIGS. 1 and 2, the battery pack 20 includes a case 19. The case 19 forms a portion of the external appearance of the lower surface of the body unit 1 in the notebook computer 30. The case 19 has a plurality of battery cells 15 accommodated in the interior thereof. The battery pack 20 is joined to a rear portion of the lower surface of the body unit 1. When the battery pack 20 is used in the notebook computer 30, support members 10 are further formed in the battery pack 20 so that the notebook computer 30 is more conveniently used. Through the support members 10 formed above, the height of the rear portion of the body unit 1 (i.e., a portion connected to the display unit 3), may be relatively higher than that of a front-end portion. Accordingly, the operation using the keyboard 7 of the notebook computer 30 can be relatively facilitated.

FIG. 2 is a perspective view showing a lower surface of the battery pack 20 according to an embodiment of the present invention. Referring to FIG. 2, the battery pack 20 includes the case 19. Eight battery cells 15 are accommodated in the interior of the case 19. In the interior of the case 19, the eight battery cells 15 are divided into two pairs of four battery cells. The four battery cells in each the two pairs are connected in series to each other. One pair of four battery cells 15 connected in series is connected in parallel with another pair of four battery cells 15. The two pairs of four battery cells 15 are spaced apart from each other at a predetermined interval in the interior of the case 19. It is understood that other numbers of cells 15 can be used, and that one or more of the cells 15 could be a fuel cell and/or primary battery instead of a secondary battery. Moreover, it is understood that the cells 15 could be removable from the case 19 so as to allow easy replacement of individual cells 15 which are no longer usable. While not shown in FIG. 2 or required in all aspects, it is understood that a cover could be placed over the case 19 such that the cells 15 would not be visible as in FIG. 1.

Groove portions 11 are formed in the interior of the case 19. The groove portions 11 are formed to be respectively recessed inward from both sides of the rear portion in the space in which the two pairs of battery cells 15 are spaced apart from each other at the predetermined interval. One of the supporting members 10 is further formed to be inserted into or protruded from each of the groove portions 11.

The case 19 includes a protection circuit module 16 in the interior thereof. The protection circuit module 16 is electrically connected to the battery cells 15. The case 19 further includes a connecting portion 14 having one side electrically connected to the battery cells 15 and the other side electrically connected to an external device. In the context of the notebook computer 30 shown in FIG. 1, the connecting portion 14 connects to the notebook computer 30, and can be permanently connected or detachably connected in aspects of the invention.

As described above, in the battery pack 20 that forms a portion of the exterior appearance of the notebook computer 30, the groove portions 11 and the support members 10 are formed in a space not occupied by the battery cell 15 (i.e., in a free space). Thus, the degree of space use can be increased, and the notebook computer 30 can be kept in its folded state when it is not used. Accordingly, the external appearance of the notebook computer 30 can be formed slimmer.

While described as having two support members 10 at opposite ends of the case 19, it is understood that other numbers can be used, and that the support members 10 and groove portions 11 can be elsewhere in the free space. Moreover, while shown as opening towards the sides of the case 19, it is understood that the support members 10 could be rotatable towards a front or back of the case 19.

FIG. 3 is an enlarged perspective view of the supporting member 10 in the battery pack 20 according to the embodiment of the present invention. Referring to FIG. 3, a rotating shaft 12 is formed in the groove portion 11. The rotating shaft 12 is joined to the support member 10 so that the support member 10 can be inserted into or protruded from the groove portion 11. As shown, a latching groove 17a is formed in one region of the groove portion 11, and a projection 17b is formed at the position corresponding to the latching groove 17a in the other region of the support member 10. That is, the latching groove 17a is formed in one wall portion of the groove portion 11, and the projection 17b is formed at the support member 10 corresponding to the latching groove 17a. Although not shown in this figure, an elastic member may be further included in the rotating shaft 12. The elastic member can elastically support the support member 10 toward the side of the latching groove 17a and the outside of the body unit of the notebook computer. When the support member 10 is inserted into the groove portion 11, the projection 17b is latched into the latching groove 17a. When the support member 10 is protruded from the outside of the groove portion 11, it may be inclined by only a predetermined angle. Further, it is understood that the groove 17a could instead be in the support member 10 and the projection 17b be in the groove portion 11 in other aspects.

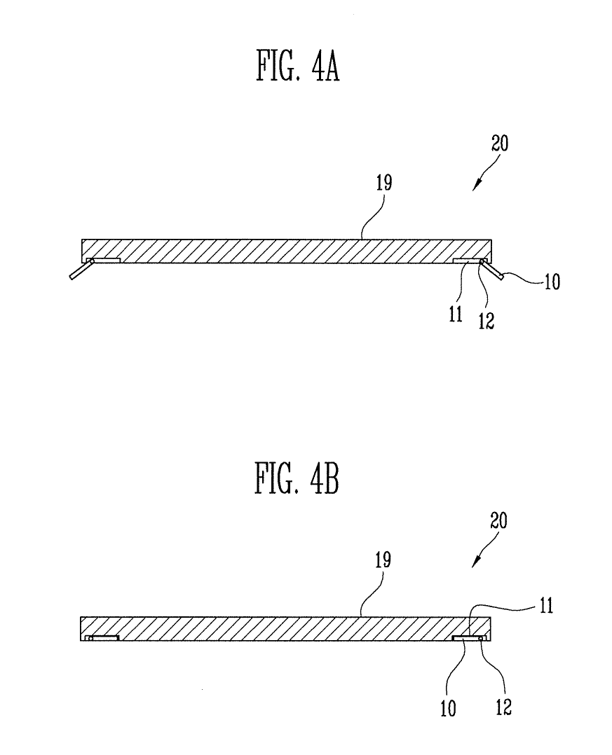

FIG. 4A is a front view showing the state that the supporting member 10 is unfolded in the battery pack 20 according to the embodiment of the present invention. FIG. 4B is a front view showing the state that the supporting member 10 is folded in the battery pack 20 according to the embodiment of the present invention.

Referring to FIGS. 1, 4A and 4B, when the notebook computer 30 having the battery pack 20 according to the embodiment of the present invention is used, both of the support members 10 respectively joined to the rotating shafts 12 of the groove portions 11 are unfolded so that each of the support members 10 is inclined at a predetermined angle. When the notebook computer 30 is kept or carried, both of the support members 10 are folded so that each of the support members 10 is inserted into the interior of the groove portion 11.

In the aforementioned embodiment, the battery pack used in the notebook computer has been described as an example. However, it will be apparent that the battery pack may be applied to other external devices using the battery pack in other aspects of the invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack for use with an external device having an external appearance, the battery pack comprising:
at least one battery cell;
a case which accommodates the at least one battery cell, the case being formed as a portion of the external appearance of the external device;
groove portions formed in a region of the case at which the at least one battery cell is not positioned in the interior of the case; and
support members respectively inserted into or protruded from the groove portions.

2. The battery pack according to claim 1, wherein the groove portions are formed at both sides of a rear portion of the external device, respectively.

3. The battery pack according to claim 1, wherein a rotating shaft is further formed in the groove portion, and the support member is joined to the rotation shaft.

4. The battery pack according to claim 1, wherein a latching groove is formed in one region of the groove portion.

5. The battery pack according to claim 4, wherein a projection is formed in the other region of the support member, corresponding to the region at which the latching groove is positioned.

6. The battery pack according to claim 1, wherein a protection circuit module is further provided in the interior of the case.

7. The battery pack according to claim 6, wherein the case is further provided with a connecting portion having one side electrically connected to the protection circuit module and the other side electrically connected to the external device.

8. The battery pack according to claim 1, wherein the external appearance of the external device is formed using case of the battery pack.
